(19) United States
(12) Patent Application Publication
(10) Pub. No.: US 2004/0227863 A1
(43) Pub. Date: Nov. 18, 2004

(54) Active matrix liquid crystal display

(76) Inventors: Cheuh-Ju Chen, Miao-Li (TW); Jia-Pang Pang, Miao-Li (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/844,895

(22) Filed: May 12, 2004

(30) Foreign Application Priority Data
May 16, 2003 (TW) 92113408

(51) Int. Cl. G02F 1/136

(52) U.S. Cl. 349/43

(57) ABSTRACT

An active matrix liquid crystal display includes a first glass layer (210), a second glass layer (220) opposite to the first substrate, a liquid crystal layer (27) disposed between the two glass layers, at least one alignment layer disposed between the two glass layers, a number of common electrodes (225) arranged on the second glass layer, an insulation layer (227) disposed on the second glass layer and the common electrodes, a number of pixel electrodes (226) arranged on the insulation layer, and a passivation layer (221) formed on the insulation layer and the side of the pixel electrodes. The common electrodes and pixel electrodes are formed at intervals. A gap between the common electrodes and the liquid crystal layer is equal to that between the pixel electrodes and the liquid crystal layer.

### BACKGROUND OF THE INVENTION

1. Field of the Invention

The present invention relates to liquid crystal displays (LCDs), and particularly to active matrix LCDs.

2. Description of Prior Art

A conventional LCD includes a plurality of electrodes arranged on two opposite substrates. The electrodes are made of transparent material and form electric fields perpendicular to the two substrates. Because liquid crystal molecules are anisotropically conductive, they are aligned perpendicular to the two substrates by the electric fields. But because of the influence of other physical forces, such as gravity, reciprocal forces between molecules, etc., the molecules cannot be aligned exactly perpendicular to the two substrates. This diminishes the clarity of the display of the LCD.

One conventional LCD is shown in FIGS. 4 and 5. The LCD 1 includes a first substrate 11, a second substrate 12, and a liquid crystal layer 17 positioned between the first substrate 11 and the second substrate 12. The first substrate 11 comprises a first glass layer 110, a first polarizer 112, a color filter 113, and a first alignment layer 114. The second substrate 12 comprises a second glass layer 120, a passivation layer 121, a second polarizer 122, a second alignment layer 124, common electrodes 125, pixel electrodes 126, an insulation layer 127, and data lines 129.

The two polarizers 112, 122 are respectively disposed on sides which are furthest away from the liquid crystal layer 17. The insulation layer 127 is disposed relatively close to the liquid crystal layer 17. The common electrodes 125 are arranged between the second glass layer 120 and the insulation layer 127. The passivation layer 121 is disposed on the insulation layer 127. The data lines 129 and pixel electrodes 126 are arranged between the insulation layer 127 and passivation layer 121. The second alignment layer 124 is disposed on the passivation layer 121. The color filter 113 is disposed on the first glass layer 110 relatively close to the liquid crystal layer 17, and the first alignment layer 114 are disposed on the color filter 113 adjacent the liquid crystal layer 17.

The polarizing axes of the two polarizers 112, 122 are perpendicular to each other. The common and pixel electrodes 125, 126 are formed at intervals. The alignment layers 114, 124 are used for controlling the tropism of the liquid crystal molecules 170. At least one of the first glass layer 110 and the second glass layer 120 is made of transparent material. The liquid crystal layer 17 is a nematic type.

Referring to FIG. 4, when no voltage is applied, the tropism of liquid crystal molecules 170 is the same as the aligning directions of the alignment layers 114, 124. The polarizing axis of the second polarizer 122 is the same as the aligning directions of alignment layers 114, 124, so that a linear polarizing light emitted from the second polarizer 122 passes through the liquid crystal layer 17 with its polarization state unchanged. However, the polarizing axes of the two polarizers 112, 122 are perpendicular to each other, so that the linear polarizing light cannot pass through the polarizer 112. In other words, the LCD 1 is dark.

Referring to FIG. 5, when voltage is applied, the common electrodes 125 and pixel electrodes 126 generate an electric field 18 parallel to the first substrate 11 and the second substrate 12. Because the liquid crystal molecules 170 are anisotropically conductive, the tropism of the crystal molecules 170 is the same as the direction of the electric field 18. Further, there is an angle between the direction of the electric field 18 and the polarizing axis of the polarizer 122, so that a linear polarizing light emitted from the polarizer 122 into the liquid crystal layer 17 undergoes birefringence. That is, the polarization state of the linear polarizing light is changed. However, the polarizing axes of the two polarizers 112, 122 are perpendicular to each other; consequently, parts of the linear polarizing light can pass through the polarizer 112. In other words, the LCD 1 is bright.

This method of controlling liquid crystal molecules 170 by applying an electric field parallel to the substrates is known as in plane switching (IPS). IPS is particularly useful in an active matrix LCD in order to enlarge the viewing angle of the LCD.

There are the insulation layer 127, the passivation layer 121 and the second alignment layer 124 between the common electrodes 125 and the liquid crystal layer 17. There are the passivation layer 121 and the second alignment layer 124 between the pixel electrodes 126 and the liquid crystal layer 17. Consequently, the distance between the common electrodes 125 and the liquid crystal layer 17 is different from the distance between the pixel electrodes 126 and the liquid crystal layer 17. That is, the common electrodes 125 exert a first force to particles in the liquid crystal layer 17, and the pixel electrodes 126 exert a second force to the particles. The first force is different from the second one.

Because the liquid crystal layer 17 can absorb particles from its surroundings, and because polarities of the common electrodes 125 and the pixel electrodes 126 are always changed during the course of driving the LCD 1, the number of particles absorbed by the common electrodes 125 and the number of particles absorbed by pixel electrodes 126 are different. Therefore, the intensity of the electric field 18 is weakened. The number of liquid crystal molecules 170 that are twisted is decreased, and the speed at which the liquid crystal molecules 170 twist is decreased. That is, the LCD 1 image delay occurs. In other words, the display the LCD 1 is not clear.

### SUMMARY OF THE INVENTION

An object of the present invention is to provide an active matrix LCD having a clear display.

In order to achieve the object set forth, an active matrix LCD in accordance with one embodiment of the present invention comprises a first glass layer, a second glass layer opposite to the first glass layer, a liquid crystal layer between the two glass layers, at least one alignment layer between the two glass layers, common electrodes arranged on the second glass layer, an insulation layer disposed on the second glass layer and the common electrodes, pixel electrodes arranged on the insulation layer, and a passivation layer formed on the insulation layer and the side of the pixel electrodes. The common electrodes and pixel electrodes are formed at intervals, and a gap between the common electrodes and the liquid crystal layer is equal to a gap between the pixel electrodes and the liquid crystal layer.

Other objects, advantages and novel features of the invention will become more apparent from the following detailed description when taken in conjunction with the accompanying drawings, in which:

### BRIEF DESCRIPTION OF THE DRAWINGS

FIG. 1 is a part diagrammatic view showing an operation state of an active matrix LCD according to a first embodiment of the present invention, in which an electric field is applied;

FIG. 2 is a part diagrammatic view showing an operation state of an active matrix LCD according to a second embodiment of the present invention, in which an electric field is applied;

FIG. 3 is a part diagrammatic view showing an operation state of an active matrix LCD according to a third embodiment of the present invention, in which an electric field is applied;

FIG. 4 is a part diagrammatic view showing an operation state of a conventional active matrix LCD, in which no electric field is applied; and

FIG. 5 is a part diagrammatic view showing the operation state of the LCD shown in FIG. 4, in which an electric field is applied.

### DETAILED DESCRIPTION OF THE INVENTION

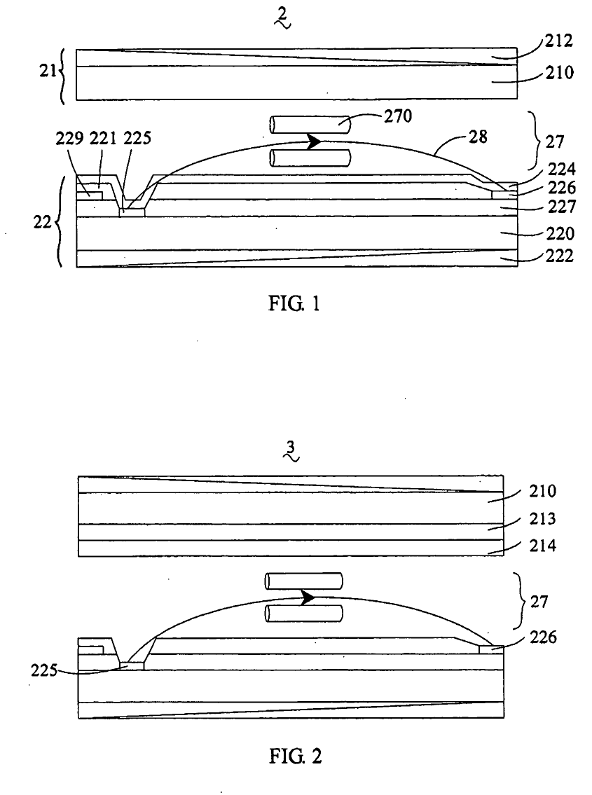

Referring to FIG. 1, an active matrix LCD 2 includes a first substrate 21, a second substrate 22 opposite to the first substrate 21, and a liquid crystal layer 27 between the two substrates 21, 22. The first substrate 21 comprises a first glass layer 210 and a first polarizer 212. The second substrate 22 comprises a second glass layer 220, a passivation layer 221, a second polarizer 222, a second alignment layer 224, common electrodes 225, pixel electrodes 226, an insulation layer 227, and data lines 229.

The two polarizers 212, 222 are respectively disposed on opposite sides of the liquid crystal layer 27, and are furthest away from the liquid crystal layer 27. The insulation layer 227 is disposed relatively close to the liquid crystal layer 27. The common electrodes 225 are arranged between the second glass layer 220 and the insulation layer 227. The passivation layer 221 is disposed on the insulation layer 227. The data lines 229 and pixel electrodes 226 are arranged generally between the insulation layer 227 and the passivation layer 221. The second alignment layer 224 is disposed on the passivation layer 221. The color filter 213 is disposed on the first glass layer 210 relatively close to the liquid crystal layer 27.

The common and pixel electrodes 225, 226 are formed at intervals and adjacent the second alignment layer 224. When a voltage is applied, the common pixel electrodes 225, 226 generate an electric field 28. At least one of the first and second substrates 21, 22 is made of transparent material. The common and pixel electrodes may be made of any of indium tin oxide (ITO), gold (Au), silver (Ag), copper (Cu), and so on. The liquid crystal layer 27 is a nematic type.

A gap between the common electrodes 225 and the liquid crystal layer 27 is the same as a thickness of the second alignment layer 224. Similarly, a gap between the pixel electrodes 226 and the liquid crystal layer 27 is the same as the thickness of the second alignment layer 224. That is, the gap between the common electrodes 225 and the liquid crystal layer 27 is equal to the gap between the pixel electrodes 226 and the liquid crystal layer 27. Therefore, when there are charged particles in the liquid crystal layer 27, the common electrodes 225 exert a force on the charged particles which is the same as a force exerted on the charged particles by the pixel electrodes 226.

Because polarities of the common electrodes 225 and the pixel electrodes 226 are always changed during the course of driving the active matrix LCD 2, the charged particles do not gather at the common electrodes 225 or the pixel electrodes 226. That is, the active matrix LCD 2 can avoid image delay occurring.

An active matrix LCD 3 of a second embodiment of the present invention is shown in FIG. 2. Compared with the active matrix LCD 2 of FIG. 1, the active matrix LCD 3 includes a first alignment layer 214 arranged adjacent the liquid crystal layer 27 of the first glass layer 210, and a color filter 213 disposed between the first glass layer 210 and the first alignment layer 214. The first alignment layer 214 replaces the second alignment layer 224 of the active matrix LCD 2.

Because the common electrodes 225 and the pixel electrodes 226 are all adjacent the liquid crystal layer 27, when there are charged particles in the liquid crystal layer 27, the common electrodes 225 exert a force on the charged particles which is the same as a force exerted on the charged particles by the pixel electrodes 226. In addition, because polarities of the common electrodes 225 and the pixel electrodes 226 are always changed during the course of driving the active matrix LCD 3, the charged particles do not gather at the common electrodes 225 or the pixel electrodes 226. That is, the active matrix LCD 3 can avoid image delay occurring.

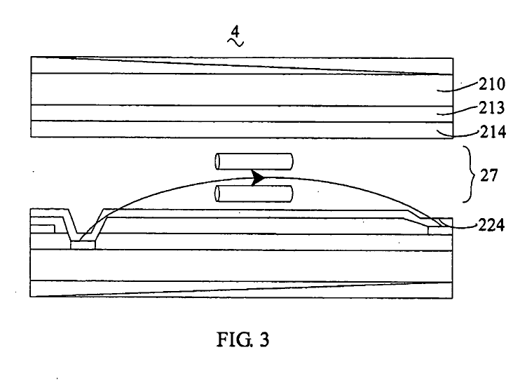

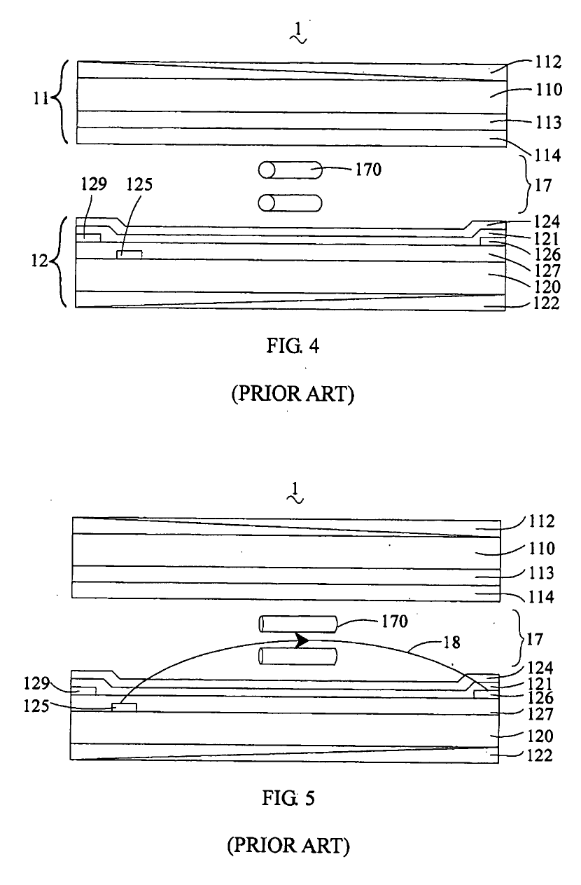

An active matrix LCD 4 of a third embodiment of the present invention is shown in FIG. 3. Compared with the active matrix LCD 2 of FIG. 1, the active matrix LCD 4 includes a first alignment layer 214 arranged adjacent the liquid crystal layer 27, and a color filter 213 disposed between the first glass layer 210 and the first alignment layer 214. The first alignment layer 214 is provided in addition to the second alignment layer 224. Like the active matrix LCDs 2, 3, the active matrix LCD 4 can avoid image delay occurring.

Various other alternative embodiments of the present invention may be constructed. For example, the first and second glass layers 210, 220 may instead be made of silicon oxide. The common electrodes 225 may be arranged obliquely relative to the pixel electrodes 226. The insulation layer 227 may comprise silicon oxide or silicon nitride.

In the active matrix LCD 2, 3, 4 of the present invention, the gap between the common electrodes 225 and the liquid crystal layer 227 is equal to that between the pixel electrodes 226 and the liquid crystal layer 27. That is, when there are charged particles in the liquid crystal layer 27, the common electrodes 225 exert a force on the charged particles which is the same as a force exerted on the charged particles by the pixel electrodes 226. Therefore, the active matrix LCD 2, 3, 4 can avoid the occurrence of image delay. The display efficacy of the active matrix LCD 2, 3, 4 of the present invention is superior to that of conventional LCDs.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. An active matrix liquid crystal display, comprising:
a first glass layer and a second glass layer opposite to the first glass layer;
a liquid crystal layer disposed between the two glass layers;
at least an alignment layer disposed between the two glass layers;
common electrodes and pixel electrodes arranged on the second glass layer;
an insulation layer disposed on the second glass layer and the common electrodes;
pixel electrodes arranged on the insulation layer; and
a passivation layer formed on the insulation layer and the pixel electrodes; wherein
a gap between the common electrodes and the liquid crystal layer is equal to that between the pixel electrodes and the liquid crystal layer.

2. The active matrix liquid crystal display of claim 1, wherein one alignment layer is arranged on the first glass layer adjacent the liquid crystal layer.

3. The active matrix liquid crystal display of claim 2, further comprising a color filter disposed between the first glass layer and said one alignment layer.

4. The active matrix liquid crystal display of claim 2, further comprising an alignment layer arranged on the second glass layer adjacent the liquid crystal layer.

5. The active matrix liquid crystal display of claim 1, wherein the common and pixel electrodes are formed parallel to each other.

6. The active matrix liquid crystal display of claim 1, wherein the common and pixel electrodes are made of indium tin oxide (ITO) or metal.

7. The active matrix liquid crystal display of claim 1, further comprising an insulation layer disposed on the second glass layer and the pixel electrodes.

8. The active matrix liquid crystal display of claim 7, wherein the insulation layer is made of silicon oxide or silicon nitride.

9. The active matrix liquid crystal display of claim 7, wherein the pixel electrodes are arranged on the insulation layer.

10. The active matrix liquid crystal display of claim 9, further comprising a passivation layer formed on the insulation layer and the pixel electrodes.

11. The active matrix liquid crystal display of claim 1, wherein at least one of the first and second glass layers is instead made of silicon oxide.

12. An active matrix liquid crystal display, comprising:
a first substrate including a first glass layer, and a first alignment layer;
a second substrate opposite to the first substrate including a second glass layer, common electrodes arranged on the second substrate, an insulation layer disposed on the second substrate and the common electrodes, pixel electrodes arranged on the insulation layer, and a passivation layer formed on the insulation layer and the pixel electrodes, a second alignment layer arranged on the passivation layer; and
a liquid crystal layer disposed between the two substrates.

13. The active matrix liquid crystal display of claim 12, wherein a gap between the common electrodes and the liquid crystal layer is equal to that between the pixel electrodes and the liquid crystal layer.

14. The active matrix liquid crystal display of claim 12, wherein the first alignment layer is adjacent the liquid crystal layer.

15. The active matrix liquid crystal display of claim 14, further comprising a color filter disposed between the first substrate and the first alignment layer.

16. The active matrix liquid crystal display of claim 12, further comprising a second alignment layer arranged on the second substrate relatively close to the liquid crystal layer.

17. The active matrix liquid crystal display of claim 12, wherein the common and pixel electrodes are formed parallel to each other.

18. The active matrix liquid crystal display of claim 12, wherein the common and pixel electrodes are made of indium tin oxide (ITO) or metal.

19. An active matrix liquid crystal display comprising:
opposite first and second substrates having a liquid crystal layer disposed therebetween; and
common electrodes and pixel electrodes arranged in the second substrate; wherein
both said common electrodes and said pixel electrodes confront said liquid crystal layer in a vertical direction with a same distance so that both the common electrodes and said pixel electrodes apply a same force upon particles in the liquid crystal layer.

20. The active matrix liquid crystal display of claim 19, wherein a vertical level of the common electrodes is lower than that of the pixel electrodes with a distance essentially to a thickness of an insulative layer in said second substrate.
